(19) United States
(12) Patent Application Publication
(10) Pub. No.: US 2016/0357221 A1
(43) Pub. Date: Dec. 8, 2016

(54) USER TERMINAL APPARATUS AND METHOD OF CONTROLLING THE SAME

(71) Applicant: SAMSUNG ELECTRONICS CO., LTD., Suwon-si (KR)

(72) Inventor: Jae-young HUH, Seoul (KR)

(73) Assignee: SAMSUNG ELECTRONICS CO., LTD., Suwon-si (KR)

(21) Appl. No.: 15/018,917

(22) Filed: Feb. 9, 2016

(30) Foreign Application Priority Data
Jun. 4, 2015 (KR) 10-2015-0079256

(51) Int. Cl. G06F 1/16; G06K 9/00; G06F 3/041; G06F 3/0484; G06F 3/03; G06F 3/0346

(52) U.S. Cl. CPC G06F 1/1652; G06F 3/0304; G06F 3/0346; G06F 3/041; G06F 3/04845; G06K 9/00006; G06F 2203/04108; G06F 2203/04102

(57) ABSTRACT

A user terminal apparatus includes a flexible display configured to be divided into a first region and a second region in response to the user terminal apparatus being bent, a bending detector configured to detect a bending state of the user terminal apparatus, a sensor configured to detect a use environment of the user terminal apparatus, and a controller configured to detect the use environment of the user terminal apparatus through the sensor in response to bending of the user terminal apparatus being detected through the bending detector, and determine whether to perform a function corresponding to the bending of the user terminal apparatus according to the detected use environment.

### CROSS-REFERENCE TO RELATED APPLICATION(S)

This application claims priority from Korean Patent Application No. 10-2015-0079256, filed on Jun. 4, 2015, in the Korean Intellectual Property Office, the disclosure of which is incorporated herein by reference in its entirety.

### BACKGROUND

Field

Apparatuses and methods consistent with exemplary embodiments relate to a user terminal apparatus and a method of controlling the same, and more particularly, to a user terminal apparatus including a flexible display that may be bent to divide it into a first region and a second region, and a method of controlling the same.

Description of the Related Art

Due to the development of display technology, a variety of user terminal apparatuses, including flexible displays, are emerging. Flexible displays may refer to bendable display apparatuses.

Flexible displays may provide flexibility to be foldable or spreadable by replacing a glass substrate which seals a liquid crystal (LC) with a plastic film in liquid crystal displays (LCDs), or by replacing a glass substrate with a plastic film in organic light emitting diodes (OLEDs). Because flexible displays use a plastic substrate rather than glass substrates, a low-temperature fabricating process may be used to prevent the substrate from being damaged.

The flexible displays may be thin, light, and shock-resistant. The flexible displays may be foldable or bendable and may be manufactured in various forms. The flexible displays may be used in industrial fields in which existing glass substrate-based displays may have limited application.

For example, the flexible displays may be applied to electronic book (e.g., e-book, e-reader) fields which substitute for publications such as magazines, textbooks, books, or cartoons, etc., and new portable information technology (IT) product fields such as subminiature personal computers (PCs) that are portable by folding or rolling a display or smart cards and provide information at all times. Because flexible displays use flexible plastic substrates, the flexible displays may further be applied to wearable clothes fashion fields, medical diagnostic fields, and the like.

As flexible displays become commercialized, new interfacing methods and new information display methods using the flexible displays are studied by using bending or folding characteristics of the flexible displays.

The user terminal apparatuses may control various functions according to bending interactions using the bending characteristics of the flexible display apparatuses. For example, the user terminal apparatuses may accept a phone call request and activate a display screen through the bending interactions.

However, flexible displays may be bent for non-interactive reasons as well (e.g., bending in a bag or pouch and the like), and thus there may be a need for a method for preventing malfunctions of the user terminal apparatuses.

### SUMMARY

Exemplary embodiments may overcome the above disadvantages and other disadvantages not described above. Also, an exemplary embodiment is not required to overcome the disadvantages described above, and an exemplary embodiment may not overcome any of the problems described above.

One or more exemplary embodiments relate to a user terminal apparatus that may prevent a malfunction due to bending by a user, and a method of controlling the same.

According to an aspect of an exemplary embodiment, there is provided a user terminal apparatus including a flexible display configured to be divided into a first region and a second region in response to the user terminal apparatus being bent; a bending detector configured to detect a bending angle of the user terminal apparatus; at least one sensor configured to detect a use environment of the user terminal apparatus; and a controller configured to: determine whether the user terminal apparatus is in a bended state or an unbended state according to the bending angle of the user terminal apparatus; detect the use environment of the user terminal apparatus through the at least one sensor in response to determining that the user terminal apparatus is in the bended state; and determine whether to perform a function corresponding to the bended state of the user terminal apparatus according to the detected use environment.

The at least one sensor may include an illumination sensor configured to detect an illumination value representing an amount of illumination near the user terminal apparatus, and wherein the controller may be further configured to not perform the function corresponding to the bended state of the user terminal apparatus in response to detecting that the illumination value is less than a predetermined value.

The at least one sensor may include a proximity sensor configured to detect an object near the user terminal apparatus, and wherein the controller may be further configured to not perform the function corresponding to the bended state of the user terminal apparatus in response to detecting that an object is within a predetermined distance of the user terminal apparatus.

The at least one sensor may include an acceleration sensor configured to detect a motion of the user terminal apparatus, and wherein the controller may be further configured to not perform the function corresponding to the bended state of the user terminal apparatus in response to detecting a predetermined motion.

The controller may be further configured to, in response to the user terminal apparatus being in a sleep mode or a standby mode, determine whether to perform the function corresponding to the bended state of the user terminal apparatus according to the detected use environment.

The user terminal apparatus may further include a fingerprint recognizer configured to recognize a fingerprint of a user, wherein the controller may be further configured to, in response to a fingerprint of a user being recognized through the fingerprint recognizer, perform the function corresponding to the bended state of the user terminal apparatus regardless of the detected use environment.

The controller may be further configured to, in response to a call request being received, accept the call request if the user terminal apparatus is in the bended state, and determine whether to end the call according to a sensing value detected through the at least one sensor in response to detecting that the user terminal apparatus enters the unbended state while the call is being performed.

The at least one sensor may include at least one of a proximity sensor and an illumination sensor, and the controller may be further configured to, in response to detecting that the user terminal apparatus enters the unbended state, maintain the call if the proximity sensor or the illumination sensor detects that the user terminal apparatus is close to a user.

The at least one sensor may include a touch sensor, and wherein the controller may be further configured to, in response to the bended state of the user terminal apparatus being detected within a predetermined time after a touch is recognized through the touch sensor, perform the function corresponding to the bended state of the user terminal apparatus, and in response to the bended state of the user terminal apparatus not being detected within the predetermined time after the touch is recognized through the touch sensor, perform a function corresponding to the touch.

According to an aspect of an exemplary embodiment, there is provided a method of controlling a user terminal apparatus, the method including: detecting a bending angle of the user terminal apparatus; determining whether the user terminal is in a bended state or an unbended state according to the bending angle of the user terminal apparatus; detecting a use environment of the user terminal apparatus in response to determining that the user terminal apparatus is in the bended state; and determining whether to perform a function corresponding to the bended state of the user terminal apparatus according to the detected use environment.

The detecting of the use environment of the user terminal apparatus may include detecting an illumination value representing an amount of illumination near the user terminal apparatus using an illumination sensor, and the determining may include determining that the function corresponding to the bended state of the user terminal apparatus is not performed in response to the illumination value detected through the illumination sensor being less than a predetermined value.

The detecting of the use environment of the user terminal apparatus may include detecting an object near the user terminal apparatus through a proximity sensor, and the determining may include determining that the function corresponding to the bended state of the user terminal apparatus is not performed in response to an object being detected within a predetermined distance of the user terminal apparatus through the proximity sensor.

The detecting of the use environment of the user terminal apparatus may include detecting a motion of the user terminal apparatus through an acceleration sensor, and the determining may include determining that the function corresponding to the bended state of the user terminal apparatus is not performed in response to a predetermined motion being detected through the acceleration sensor.

The determining may include determining, in response to the user terminal apparatus being in a sleep mode or a standby mode, whether to perform the function corresponding to the bended state of the user terminal apparatus according to the detected use environment.

The method may include recognizing a fingerprint of a user, and wherein the determining may include determining that the function corresponding to the bended state of the user terminal apparatus is performed regardless of the detected use environment in response to a fingerprint of a user being recognized through a fingerprint recognizer.

The method may include receiving a call request; accepting the call request in response to detecting that the user terminal apparatus is in the bended state; and determining whether to end a call according to a sensing value detected through the sensor of the user terminal apparatus in response to detecting that the user terminal apparatus enters the unbended state.

The sensor may include at least one of a proximity sensor and an illumination sensor, and the determining whether to end the call may include maintaining the phone call in response to determining through the proximity sensor or the illumination sensor that the user terminal apparatus is close to a user when the user terminal apparatus enters the unbended state.

The method may include performing the function corresponding to the bended state of the user terminal apparatus in response to the bended state of the user terminal apparatus being detected within a predetermined time after a touch of the user terminal apparatus is recognized through a touch sensor; and performing a function corresponding to the touch of the user terminal apparatus in response to the bended state of the user terminal apparatus not being detected within the predetermined time after the touch of the user terminal apparatus is recognized through the touch sensor.

According to another aspect of an exemplary embodiment, there is provided a user terminal apparatus including: a flexible display configured to be bent by a user; a bending detector configured to detect a bending angle of the flexible display; a controller configured to: determine whether the user terminal apparatus is in a bended state or an unbended state according to the detected bending angle; and in response to determining that the user terminal apparatus changes from the unbended state to the bended state, divide the flexible display into a first region and a second region.

The first region may be configured to display a first function of a currently executed application and the second region may be configured to display a second function of the currently executed application.

The currently executed application may be at least one of an email application, a text application, a camera application, and a memo application.

In response to the currently executed application being a camera application, the first function may include displaying an image capture screen and the second function may include displaying an image capture button.

In response to the currently executed application being a text application, the first function may include displaying a text application and the second function may include displaying a keyboard input.

According to one or more exemplary embodiments, the user terminal apparatus may prevent a malfunction due to bending too far by the user.

Additional aspects of the exemplary embodiments are set forth in the detailed description, and will be apparent from the detailed description, or may be learned by practicing the exemplary embodiments.

### BRIEF DESCRIPTION OF THE DRAWINGS

The above and/or other aspects will be more apparent by describing one or more exemplary embodiments with reference to the accompanying drawings, in which:

FIGS. 1A, 1B, and 1C are diagrams illustrating bending of a user terminal apparatus according to an exemplary embodiment;

FIG. 2 is a block diagram illustrating a configuration of a user terminal apparatus according to an exemplary embodiment;

FIG. 3 is a block diagram illustrating a configuration of a user terminal apparatus according to an exemplary embodiment;

FIG. 4 is a block diagram illustrating a structure of software stored in a user terminal apparatus according to an exemplary embodiment;

FIGS. 5 to 8 are flowcharts illustrating a malfunction prevention method of a user terminal apparatus according to one or more exemplary embodiments;

FIGS. 9A to 14D are diagrams examples of providing various functions according to a bending operation of a user terminal apparatus according to one or more exemplary embodiments;

FIG. 15 is a flowchart illustrating a control method of a user terminal apparatus according to an exemplary embodiment; and

FIG. 16 is a diagram illustrating a user terminal apparatus in which a rear side is divided into two covers according to an exemplary embodiment.

### DETAILED DESCRIPTION OF EXEMPLARY EMBODIMENTS

Terms used in exemplary embodiments will be described below, and exemplary embodiments will be described in detail.

Terms may be used in consideration of certain functions, but other terms may also be used depending on the intention of those of ordinary skill in the art, precedents, the appearance of new technology, and the like. Accordingly, the terms in the exemplary embodiments may be defined based not only on the names of the terms but also based on the meanings of the terms and contents over the exemplary embodiments.

It will be understood that, although the terms first, second, etc., may be used in reference to elements, such elements should not be construed as limited by these terms. The terms are used to distinguish one element from other elements. For example, a first element may refer to a second element, and similarly, a second element may refer to a first element. The term “and/or” may include a combination of a plurality of related items described, or may include any item among the plurality of related items.

According to exemplary embodiments, the articles “a,” “an,” and “the” are singular in that they have a single reference; however, the use of the singular form in the present disclosure should not preclude the presence of more than one reference. In other words, elements referred to in the singular may number one or more, unless the context clearly indicates otherwise.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

According to one or more exemplary embodiments, “module” or “unit” may perform at least one function or operation, and may be implemented with hardware, software, or a combination thereof. “Plurality of modules” or “plurality of units” may be implemented with at least one processor through integration thereof with at least one module other than “module” or “unit” which may be implemented with specific hardware.

According to one or more exemplary embodiments, the phrase “coupled” to another portion may include “directly coupled” as well as “electrically coupled” with one or more elements interposed therebetween.

According to one or more exemplary embodiments, a user input may include at least one of a touch input, a bending input, a voice input, and a multimodal input, but the user input is not limited thereto.

According to one or more exemplary embodiments, “touch input” may include a touch gesture performed with respect to a display and a cover for the user to control an apparatus. “Touch input” may include a touch (e.g., floating or hovering) in a state no-contacted onto a display and spaced from the display. “touch input” may include a touch and hold gesture, a tap gesture released after a touch, a double tap gesture, a panning gesture, a flick gesture, a touch drag gesture moving to one direction after a touch, a pinch gesture, and the like, but the touch input is not limited thereto.

According to one or more exemplary embodiments, “bending input” may refer to an input for causing a user terminal apparatus to be bent for the user to control the apparatus. The user terminal apparatus may be bent through a preset bending line or an arbitrary bending line.

According to one or more exemplary embodiments, “multimodal input” may refer to a combination of at least two or more input types. For example, an apparatus may receive a touch input and a bending input of the user, and the apparatus may receive a touch input and a voice input of the user.

According to one or more exemplary embodiments, “application” may refer to a set of computer programs designed to perform tasks. The application may be versatile. For example, the application may include a game application, a moving image reproduction application, a map application, a memo application, a calendar application, a phone book application, a broadcast application, an exercise support application, a payment application, a photo folder application, and the like, but the application is not limited thereto.

According to one or more exemplary embodiments, “application identification information” may be unique information for distinguishing an application from other applications. For example, the application identification information may include at least one of an icon, an index item, link information, and the like, but the application identification information is not limited thereto.

According to one or more exemplary embodiments, a user interface (UI) element may refer to an element capable of interacting with the user and capable of at least one of visual, auditory, and olfactory feedbacks according to the user input. For example, the UI element may be represented by at least one of an image, text, and a moving image. In another example, in response to the above-described information not being displayed and one region capable of the feedback according to the user input being presented, the one region may refer to the UI element. In another example, the UI element may be the above-described application identification information.

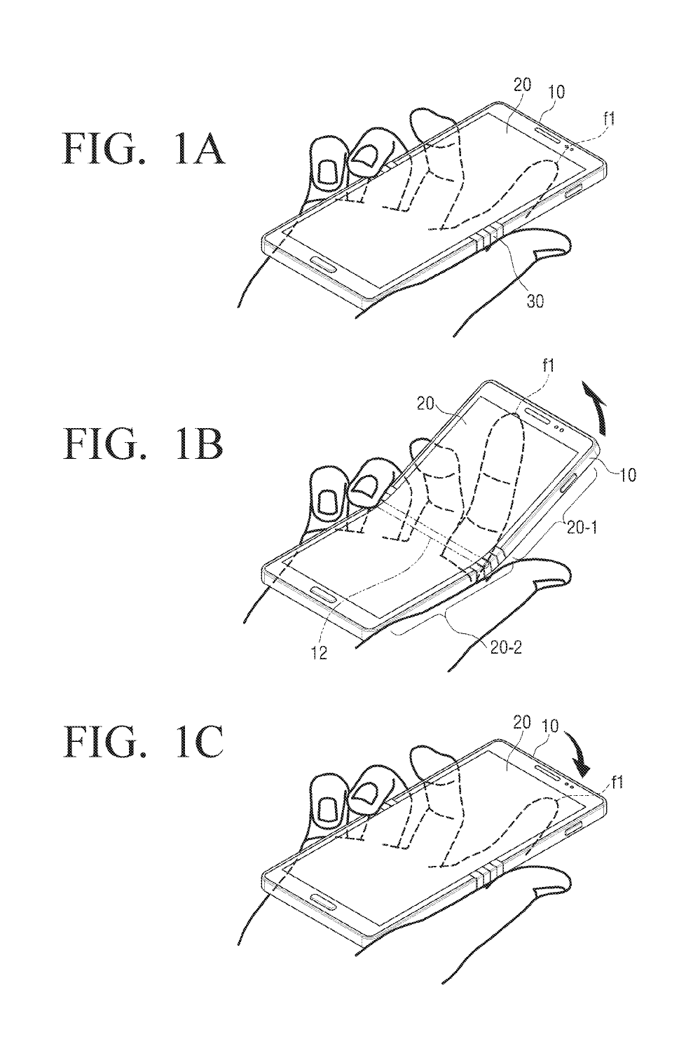

According to one or more exemplary embodiments, “bending state of user terminal apparatus” may refer to a bent state of a user terminal apparatus. According to one or more exemplary embodiment, “unbending state of user terminal apparatus” may refer to a spread state of a user terminal apparatus. The detailed definition thereof will be described below with reference to FIGS. 1A, 1B, and 1C.

Unless otherwise defined, all the terms including technical or scientific terms used herein may have a meaning as that commonly understood by those of ordinary skill in the art.

FIGS. 1A, 1B, and 1C are diagrams illustrating various states of a bendable user terminal apparatus according to an exemplary embodiment.

Referring to FIGS. 1A, 1B, and 1C, a bendable display apparatus 10 may be implemented with multipurpose devices. For example, according to an exemplary embodiment, the user terminal apparatus 10 may include a portable phone, a smart phone, a laptop computer, a tablet device, an e-book device, a digital broadcasting device, a personal digital assistant (PDA), a portable multimedia player (PMP), a navigation, a wearable device such as a smart watch, smart glasses, a head-mounted display (HMD), and the like.

The bendable user terminal apparatus 10 may employ the flexible display 20. The flexible display 20 may include various types of displays which are deformable by external force such as a foldable display which may be foldable to a specific angle or a specific curvature or spreadable, a bendable display which may be bendable to a specific curvature or spreadable, and a rollable display which is rollable in a cylindrical form.

The flexible display 20 may have a function that provides a screen including information processed in the flexible display 20 or information to be processed in the flexible display 20, such as a LCD or a light emitting diode (LED) display. For example, the flexible display 20 may display an execution screen of an application program, a locking screen, a wallpaper screen, a home screen, and the like.

The flexible display 20 may include an input interfacing function of a touch screen or a touch pad. Accordingly, the flexible display 20 may detect a touch input of the user, and the user terminal apparatus 10 may be controlled according to the detected touch input.

For example, the user terminal apparatus 10 may maintain a bending state bent from an unbending state while external pressure is applied. The user terminal apparatus 10 may return to the unbending state in response to the external pressure being removed. In another example, the user terminal apparatus 10 may maintain the unbending state from the bending state while the external pressure is applied. In response to the external pressure being removed, the user terminal apparatus 10 may return to the bending state.

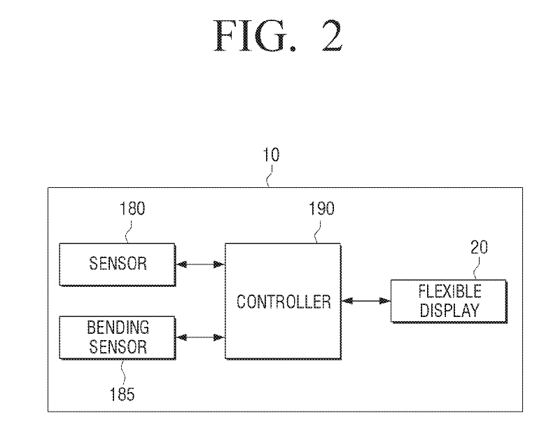

FIG. 1A illustrates a case in which the user grips the user terminal apparatus 10 which is in an unbending state. The user terminal apparatus 10 may include a flexible display 20 and a bending part 30. The bending part 30 may include a component configured to allow the user terminal apparatus 10 to be bent to a specific angle or to a specific curvature and a component configured to allow the user terminal apparatus 10 to return to an unbending state. According to the implemented type, the bending part 30 may further include a bending sensor (e.g., bending detector) 185 (FIG. 2) configured to detect a bending state of the user terminal apparatus 10.

External pressure may be applied to the user terminal apparatus 10 in an unbending state of the user terminal apparatus 10 as illustrated in FIG. 1A. For example, the external pressure may be force that the user pushes an upper portion of a rear of the user terminal apparatus 10 forward using a finger fl.

In this example, the user terminal apparatus 10 may be changed from the unbending state to the bending state on the basis of one axis 12 as illustrated in FIG. 1B. In response to the user terminal apparatus 10 being bent, the flexible display 20 may be divided into a first region 20-1 and a second region 20-2. The first region 20-1 may be a flexible display region 20 located above the one axis 12 and the second region 20-2 may be the remaining region (e.g., a region located below the one axis 12) of the flexible display 20. For example, the first region 20-1 may be about 40% of a display region in the flexible display 20, but the first region 20-1 is not limited to this.

In this example, as illustrated in FIG. 1C, the user terminal apparatus 10 may be changed from the bending state to the unbending state on the basis of the one axis 12 again.

In FIGS. 1A, 1B, and 1C, the bending part 30 is disposed in parallel to a horizontal axis of the user terminal apparatus 10, but this is merely exemplary. The bending part 30 may be disposed in parallel to a vertical axis. FIGS. 1A, 1B, and 1C illustrate only one bending part 30, but this is merely exemplary. A plurality of bending parts may be included.

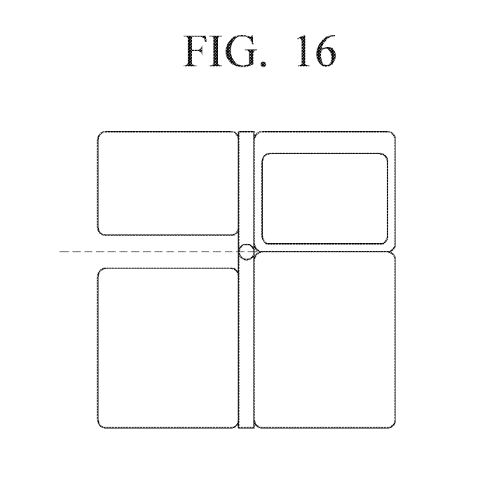

To protect the bendable display apparatus 10, the user terminal apparatus 10 may be covered with a cover device as illustrated in FIG. 16. For the bending of the user terminal apparatus 10, a rear side of the cover device may be divided into two covers.

FIG. 2 is a block diagram illustrating a configuration of a user terminal apparatus according to an exemplary embodiment.

Referring to FIG. 2, the user terminal apparatus 10 may include a flexible display 20, a sensor 180, the bending sensor 185, and a controller 190. In FIG. 2, components related to an exemplary embodiment are illustrated. However, it should be understood that other general-purpose components may be included in addition to the components illustrated in FIG. 2 by those of ordinary skill in the art.

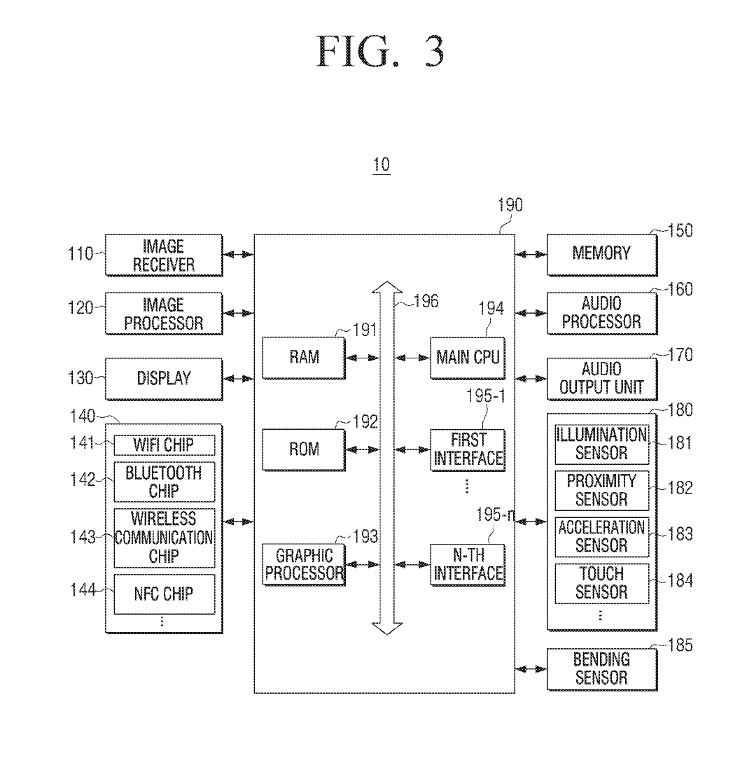

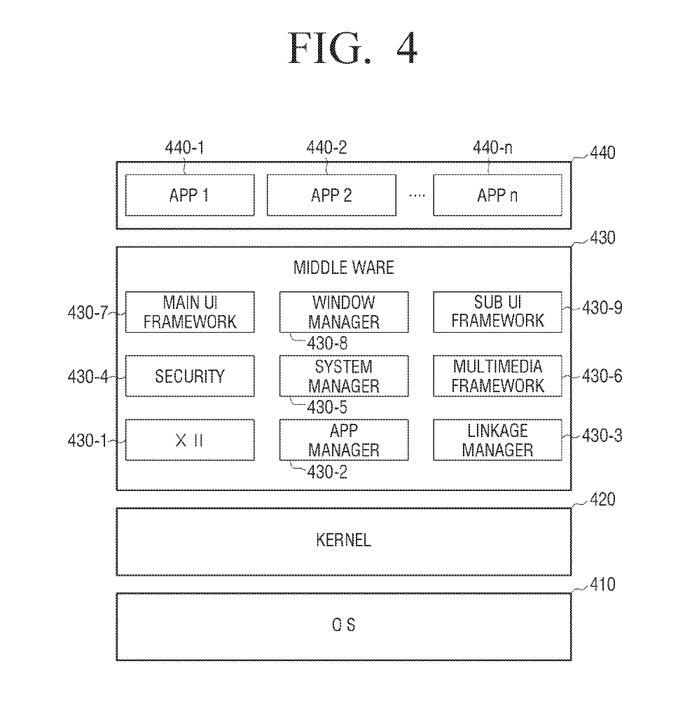

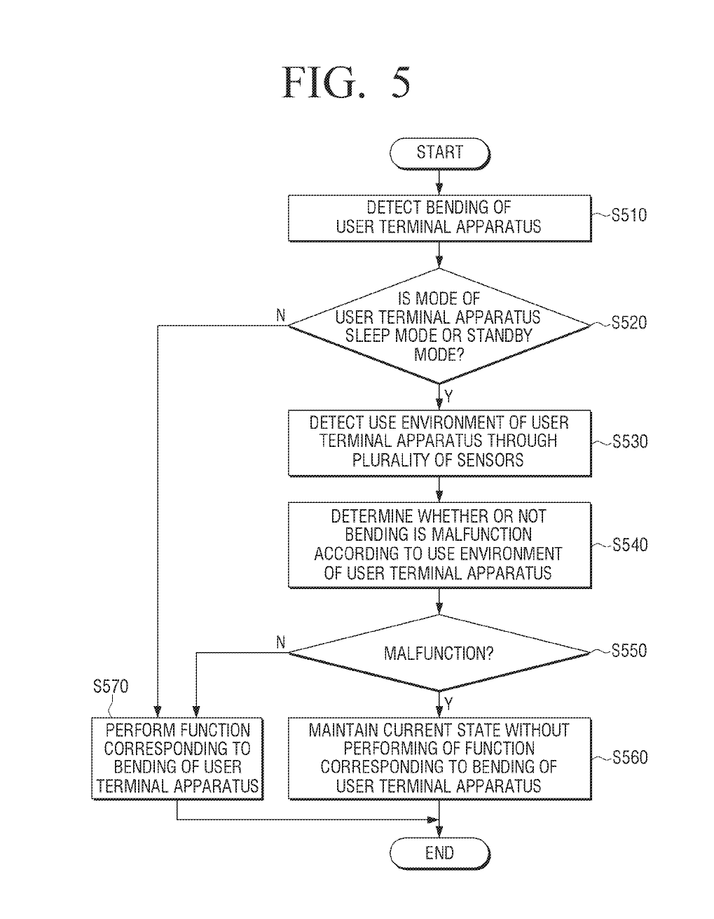

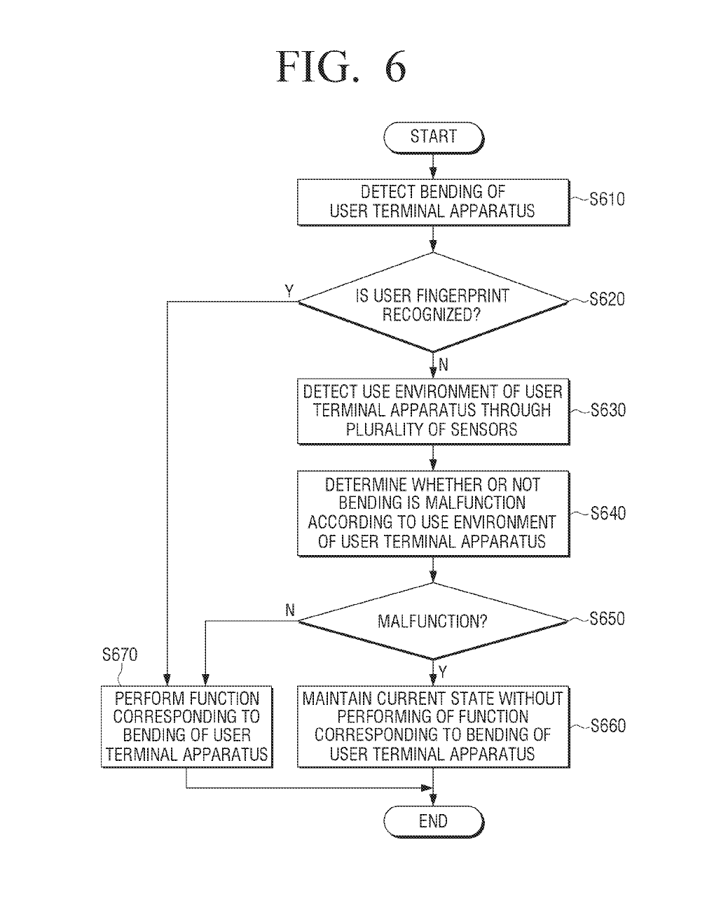

The sensor 180 may acquire various sensing values to detect a use environment of the user terminal apparatus 10. The sensor 180 may include various sensors to detect the use environment of the user terminal apparatus 10. For example, the sensor 180 may include an illumination sensor 181 configured to detect an illumination value in a periphery of the user terminal apparatus 10, a proximity sensor 182 configured to detect an object in the periphery of the user terminal apparatus 10, an acceleration sensor 183 configured to detect a motion pattern of the user terminal apparatus 10, and the like, as illustrated in FIG. 3.

The bending sensor 185 may detect a bending state of the user terminal apparatus 10. For example, the bending sensor 185 may detect at least one of bending and unbending, bending speed, a bending angle, and a bending time of the user terminal apparatus 10.

The flexible display 20 may provide at least one screen according to the bending state of the user terminal apparatus 10. For example, the flexible display 20 may provide screens to two regions in response to the user terminal apparatus 10 being bent, and the flexible display 20 may provide one screen to one region in response to the user terminal apparatus 10 being unbent. Exemplary embodiments are not limited to this.

The controller 190 may be implemented with at least one processor such as a central processing unit (CPU) or an application processor (AP). The controller 190 may perform a function to control an overall operation of the user terminal apparatus 10.

For example, in response to the bending of the user terminal apparatus 10 being detected through the bending sensor 185, the controller 190 may detect the use environment of the user terminal apparatus 10 through the sensor 180, and determine whether to perform a function corresponding to the bending of the user terminal apparatus 10 according to the detected use environment.

In this example, in response to the bending of the user terminal apparatus 10 being detected through the bending sensor 185, the controller 190 may acquire an illumination value in the periphery of the user terminal apparatus 10 using the illumination sensor 181. In response to the illumination value detected through the illumination sensor 181 being less than a preset value, the controller 190 may not perform the function corresponding to the bending of the user terminal apparatus 10. In response to the illumination value detected through the illumination sensor 181 being more than or equal to the preset value, the controller 190 may perform the function corresponding to the bending of the user terminal apparatus 10. Exemplary embodiments are not limited to this. For example, the situation may be reversed.

In response to the bending of the user terminal apparatus 10 being detected through the bending sensor 185, the controller 190 may detect whether an object is presented in the periphery of the user terminal apparatus 10 using the proximity sensor 182. In response to the object presented in the periphery of the user terminal apparatus 10 being detected through the proximity sensor 182, the controller 190 may not perform the function corresponding to the bending of the user terminal apparatus 10. In response to the object presented in the periphery of the user terminal apparatus 10 not being detected through the proximity sensor 182, the controller 190 may perform the function corresponding to the bending of the user terminal apparatus 10. Exemplary embodiments are not limited to this. For example, the situation may be reversed.

In response to the bending of the user terminal apparatus 10 being detected through the bending sensor 185, the controller 190 may detect the motion of the user terminal apparatus 10 using the acceleration sensor 183. In response to the motion having a preset pattern of the user terminal apparatus being detected through the acceleration sensor 183, the controller 190 may not perform the function corresponding to the bending of the user terminal apparatus 10. Exemplary embodiments are not limited to this. For example, the situation may be reversed.

The controller 190 may determine whether to perform the function corresponding to the bending of the user terminal apparatus 10 in consideration of the complex use environments of the user terminal apparatus 10. That is, the controller 190 may determine whether to perform the function corresponding to the bending of the user terminal apparatus 10 based on at least one from among the illumination value in the periphery of the user terminal apparatus 10, the proximity of the object to the periphery of the user terminal apparatus 10, and a motion pattern of the user terminal apparatus 10.

FIG. 3 is a detailed block diagram illustrating a configuration of the user terminal apparatus 10 according to an exemplary embodiment.

Referring to FIG. 3, the user terminal apparatus 10 may include an image receiver 110, an image processor 120, a display 130, a communication unit 140, a memory 150, an audio processor 160, an audio output unit 170, and the sensor 180, the bending sensor 185, and the controller (e.g., processor) 190.

FIG. 3 integrally illustrates various components by exemplifying that the user terminal apparatus 10 is an apparatus having various functions such as a content providing function and a display function. According to exemplary embodiments, portions of the components illustrated in FIG. 3 may be omitted or changed, and other components may be added.

The image receiver 110 may receive image data through various sources. For example, the image receiver 110 may receive broadcast data from an external broadcasting station, receive video on demand (VOD) data from an external server in real time, and receive image data from an external apparatus.

The image processor 120 may be configured to perform processing on the image data received in the image receiver 110. The image processor 120 may perform image processing on the image data, such as decoding, scaling, noise filtering, frame rate conversion, and resolution conversion for the image data.

The display 130 may display video frames in which the image data is processed in the image processor 120 or at least one of various screens generated in a graphic processor 193.

The display 130 may be implemented with various types of displays such as a LCD, an OLED, an active-matrix OLED (AMOLED), or a plasma display panel (PDP). The display 130 may further include additional configuration components according to the implementation type. For example, in response to the display 130 being implemented with an LC type, the display 130 may include a LCD display panel, a backlight unit configured to supply light to the LCD panel, a panel driver board configured to drive the LCD display panel, and the like.

If the display 130 is applied to the flexible display 20, the display 130 may be bendable, foldable, or rollable without damage through a thin and flexible substrate, like paper. The display 130 may be fabricated using a glass substrate as well as a plastic substrate. If the plastic substrate is used, the display 130 may be fabricated using a low-temperature process to prevent the substrate from being damaged. The display 130 may be flexible and therefore foldable or spreadable by replacing the glass substrate sealing the LC with the plastic substrate in a LCD, and by replacing the glass substrate with the plastic substrate in an OLED, an AM-OLED, a PDP, and the like. The display 130 may be thin, light, and shock-resistant, and may be fabricated in various forms to be bendable or foldable as described above.

The display 130 may have an active matrix screen having a screen size (e.g., 3 inches, 4 inches, 4.65 inches, 5 inches, 6.5 inches, 8.4 inches, and the like) according to a size of the user terminal apparatus 10, and the display 130 may extend to at least one side (e.g., at least one of a left side, a right side, a top side, and a bottom side) of the user terminal apparatus 10. Accordingly, the display 130 may be folded to an operable radius of curvature (or the radius of curvature of 5 cm, 1 cm, 7.5 mm, 5 mm, 4 mm, and the like) or below, and fastened to the lateral side of the user terminal apparatus 10.

The display 130 may have a touch screen having a layer structure through coupling with a touch sensor 184. The flexible display 20 with the touch screen may have a function for detecting a touch input position and a touched area as well as touch input pressure, and a function for detecting a real touch or a proximity touch.

The communication unit (e.g., communication interface) 140 may be configured to perform communication with various types of external apparatuses according to various types of communication methods. The communication unit 140 may include a wireless fidelity (Wi-Fi) chip 141, a Bluetooth chip 142, a wireless communication chip 143, a near field communication (NFC) chip 144, and the like. The controller 190 may perform communication with various types of external apparatuses using the communication unit 140.

For example, the Wi-Fi chip 141 and the Bluetooth chip 142 may perform communication in a Wi-Fi manner and a Bluetooth manner, respectively. In response to the Wi-Fi chip 141 or the Bluetooth chip 142 being used, the communication unit 140 may first transmit or receive connection information such as a service set identifier (SSID) and a session key, perform communication connection using the connection information, and transmit or receive a variety of information. The wireless communication chip 143 may be a chip configured to perform communication according to various communication standards, such as Institute of Electrical and Electronics Engineers (IEEE), Zigbee, 3rd generation (3G), 3rd Generation Partnership Project (3GPP), or Long Term Evolution (LTE). The NFC chip 144 may be a chip configured to operate in an NFC manner using various radio frequency identification (RF-ID) frequency bands such as 135 kHz, 13.56 MHz, 433 MHz, 860 to 960 MHz, and 2.45 GHz.

The memory 150 may store a variety of programs and data for an operation of the user terminal apparatus 10. The memory 150 may include a flash memory, a hard disc drive (HDD), or a solid state drive (SSD). The memory 150 may be accessed by the controller 190, and perform readout, recording, correction, deletion, update, and the like, on data by the controller 190. According to an exemplary embodiment, the memory 150 may be defined to include a read only memory (ROM) 192 and a random access memory (RAM) 191 in the controller 190 or a memory card (e.g., a micro security digital (SD) card, a memory stick, and the like) mounted on the user terminal apparatus 10.

For example, the memory 150 may store programs, data, and the like, for forming various screens to be displayed in a display region.

FIG. 4 illustrates a structure of software stored in the user terminal apparatus 10. Referring to FIG. 4, the software including an operating system (OS) 410, a kernel 420, a middle ware 430, an application 440, and the like, may be stored in the memory 150.

The OS 410 may perform a function to control and manage an overall operation of hardware. That is, the OS 410 may be a layer which serves as a basic function such as hardware management, memory, and security.

The kernel 420 may serve as a path which transfers various signals including a touch signal and the like, detected through the display 130 to the middle ware 430.

The middle ware 430 may include various types of software modules which control the operation of the user terminal apparatus 10. Referring to FIG. 4, the middle ware 430 may include an XII module 430-1, an application (APP) manager 430-2, a linkage manager 430-3, a security module 430-4, a system manager 430-5, a multimedia framework 430-6, a main user interface (UI) framework 430-7, a window manager 430-8, a sub UI framework 430-9, and the like.

The XII module 430-1 may be a module which receives various event signals from various types of hardware included in the user terminal apparatus 10. The event may be predetermined or may be set by a user such as an event that a user gesture is detected, an event that a system alarm is generated, and an event that specific program is executed or terminated.

The APP manager 430-2 may be a module which manages an execution state of various applications 440 installed in the memory 150. In response to an application execution event being detected from the XII module 430-1, the APP manager 430-2 may call an application corresponding to the corresponding event and execute the corresponding application.

The linkage manager 430-3 may be a module configured to support a wired or wireless network connection. The linkage manager 430-3 may include various detail modules such as a device net (DNET) module and a universal plug and play (UPnP) module.

The security module 430-4 may be a module which supports certification for hardware, request permission, security storage, and the like.

The system manager 430-5 may monitor states of components in the user terminal apparatus 10, and provide the monitoring result to other modules. For example, in response to low battery, an error, or communication delinkage being caused, the system manager 430-5 may output an alarm message or an alarm sound by providing the monitoring result to the main UI framework 430-7 or the sub UI framework 430-9.

The multimedia framework 430-6 may be a module configured to reproduce multimedia content stored in the user terminal apparatus 10 or provided from an external source. The multimedia framework 430-6 may include a player module, a camcorder module, a sound processing module, and the like. Accordingly, the multimedia framework 430-6 may perform a reproduction operation by reproducing various types of multimedia content and generating a screen and sound.

The main UI framework 430-7 may be a module configured to provide various UIs to be displayed in a main region of the display 130, and the sub UI framework 430-9 may be a module configured to provide various UIs to be displayed in a sub region of the display 130. The main UI framework 430-7 and the sub UI framework 430-9 may include an image compositor module which constitutes various UI elements, a coordinate compositor module which calculates coordinates in which the UI elements are to be displayed, a rendering module which renders the constituted UI elements to the calculated coordinates, a two-dimensionally/three-dimensionally (2D/3D) toolkit which provides a tool for constituting a 2D type UI or 3D type UI, and the like.

The window manager 430-8 may detect a touch event or other input events using a body of the user or a pen or stylus. In response to such an event being detected, the window manager 430-8 may transfer an event signal to the main UI framework 430-7 or the sub UI framework 430-9 to perform an operation corresponding to the event.

In another example, in response to a screen being touched and dragged by the user, various program modules such as a writing module may be configured to draw a line along a dragging trajectory or an angle calculation module may be configured to calculate a pitch angle, a roll angle, a yaw angle, and the like, based on a sensor value detected through the motion sensor 182.

The application module 440 may include applications 440-1 to 440-n configured to support various functions. For example, the application module 440 may include a program module configured to provide various types of service such as a navigation program module, a game module, an e-book module, a calendar module, or an alarm management module. The applications may be installed as a default or may be arbitrarily installed and used in a using process of the user. In response to a UI element being selected, a main CPU 194 may execute an application corresponding to the selected UI element using the application module 440.

The software structure illustrated in FIG. 4 is merely exemplary, and the present disclosure is not limited thereto. A portion of the structure may be omitted or changed or other programs may be added thereto. For example, various types of programs such a sensing module configured to analyze signals detected through various types of sensors, a messaging module such as messenger program, short message service (SMS) or multimedia message service (MMS) program, or e-mail program, a call information aggregator program module, voice over internet protocol (VoIP) module, and a web browser module may be added in the memory 150.

Referring back to FIG. 3, the audio processor 160 may be configured to perform processing on audio data of image content. The audio processor 160 may perform processing on the audio data, such as decoding, amplification, and noise filtering for the audio data. The audio data processed in the audio processor 160 may be output to the audio output unit 170.

The audio output unit 170 may be configured to output a variety of audio data on which the various processing operations such as decoding, amplification, or noise filtering are performed through the audio processor 160, or to output various alarm sounds or voice messages. For example, the audio output unit 170 may be implemented with a speaker. However, this is merely exemplary, and the audio output unit 170 may be implemented with output terminals which may output the audio data.

The sensor 180 may be configured to detect various user interactions. The sensor 180 may detect at least one change of the user terminal apparatus 10 such as posture change, illumination change, and acceleration change, and transfer electrical signals corresponding to the detected changes to the controller 190. For example, the sensor 180 may detect a use environment of the user terminal apparatus 10, generate a detection signal according to the use environment, and transfer the generated detection signal to the controller 190. According to an exemplary embodiment, the sensor 180 may include various sensors, and power may be supplied to at least one sensor according to control of the sensor 180 in driving of the user terminal apparatus 10 (or according to the user setup), and the sensor may detect a state change of the user terminal apparatus 10.

The sensor 180 may be configured to include at least one device among all types of sensing devices capable of detecting the use environment of the user terminal apparatus 10.

The sensor 180 may include the illumination sensor 181, the proximity sensor 182, the acceleration sensor 183, the touch sensor 184, and the like, according to the detection purpose as illustrated in FIG. 3. For example, the illumination sensor 181 may detect an illumination value in the periphery of the user terminal apparatus 10. The proximity sensor 182 may detect whether an object is presented in the periphery of the user terminal apparatus 10. The acceleration sensor 183 may detect a motion pattern of the user terminal apparatus 10. The touch sensor 184 may acquire an output signal according to a touch input of the user, and acquire information for a touch position, touch coordinates, the number of touches, touch intensity, a cell identification (ID), a touch angle, a touch area, and the like, based on the acquired output signal.

The sensor 180 may be configured to include various sensors such as a gyro sensor, a pressure sensor, a noise sensor (e.g., a microphone), a video sensor (e.g., a camera module), a timer, and the like, in addition to the illumination sensor 181, the proximity sensor 182, the acceleration sensor 183, and the touch sensor 184.

The bending sensor 185 may detect a bending state of the user terminal apparatus 10 using at least one among a tact switch, a motion detection sensor, and a pressure sensor as a detection sensor. The bending sensor 185 may periodically transmit a measured value from the detection sensor or the bending state of the user terminal apparatus 10 derived from the measured value to the controller 190. The bending sensor 185 may transmit the measure value or the bending state of the user terminal apparatus 10 to the controller 190 in response to the measured value being more than or equal to a threshold value, the measured value being less than or equal to the threshold value, or an event being generated.

In another example, the bending sensor 185 may detect the bending state of the user terminal apparatus 10 according to a capacitor value or a resistor value of a touch panel acquired from the touch sensor 184. For example, a bending angle of the user terminal apparatus 10 may be detected in consideration of a magnitude of a capacitor value or a resistor value of a bending portion in the touch panel. In another example, a bending speed of the user terminal apparatus 10 may be detected in consideration of a change speed of the capacitor value or the resistor value. In another example, a bending maintenance time of the user terminal apparatus 10 may be detected in consideration of a change time of the capacitor value or the resistor value.

The controller 190 may be configured to control an overall operation of the user terminal apparatus 10 using programs stored in the memory 150.

As illustrated in FIG. 3, the controller 190 may include the RAM 191, the ROM 192, the graphic processor 193, the main CPU 194, first to n-th interfaces 195-1 to 195-n, and a bus 196. The RAM 191, the ROM 192, the graphic processor 193, the main CPU 194, the first to n-th interfaces 195-1 to 195-n, and the like, may be electrically coupled through the bus 196.

A command set, and the like, for system booting is stored in the ROM 192. In response to a turn-on command being input to supply power, the main CPU 194 may copy an operating system (OS) stored in the memory 150 to the RAM 191 according to a command stored in the ROM 192, and execute the OS to boot a system. In response to the booting being completed, the main CPU 194 may copy various application programs stored in the memory 150 to the RAM 191, and execute the application programs copied to the RAM 191 to perform various operations.

The graphic processor 193 may be configured to generate a screen including various types of information such as an item, an image, and text using an operation unit and a rendering unit. The operation unit may calculate attribute values such as coordinate values, in which the various types of information are displayed according to a layout of the screen, shapes, sizes, and colors using a control command received from the sensor 180. The rendering unit may generate the screen having various layouts including the information based on the attribute values calculated in the operation unit. The screen generated in the rendering unit may be displayed in a display region of the display 130.

The main CPU 194 accesses the memory 150 to perform booting using the OS stored in the memory 150. The main CPU 194 performs operations using a variety of programs, content, data, and the like, stored in the memory 150.

The first to n-th interfaces 195-1 to 195-n are coupled to the above-described components. One of the interfaces may be a network interface coupled to an external apparatus through a network.

For example, in response to the bending input for causing the user terminal apparatus 10 to be bent being detected, the controller 190 may perform a function corresponding to the bending input. For example, in response to the bending of the user terminal apparatus being detected in a state in which a phone call request is received, the controller 190 may accept the phone call in response to the bending of the user terminal apparatus 10. In another example, in response to the bending of the user terminal apparatus 10 being detected within a preset time in a state in which a text message being received, the controller 190 may control the display 130 to display a message window in response to the bending of the user terminal apparatus 10.

That is, the controller 190 may provide various functions of the user terminal apparatus 10 through the bending input. The bending of the user terminal apparatus 10 may be intended or unintended by the user. That is, the user terminal apparatus 10 may be bent in a bag or in a pouch regardless of the user's intention. A malfunction of the user terminal apparatus 10 may be caused by a user bending the apparatus too far.

Accordingly, in response to the bending of the user terminal apparatus 10 being detected through the bending sensor 185, the controller 190 may detect the use environment of the user terminal apparatus 10 through the sensor 180, and determine whether to perform the function corresponding to the bending of the user terminal apparatus 10 according to the detected use environment.

For example, in response to the bending of the user terminal apparatus 10 being detected through the bending sensor 185, the controller 190 may acquire an illumination value in a periphery of the user terminal apparatus 10 using the illumination sensor 181. In response to the illumination value detected through the illumination sensor 181 being less than a preset value, the controller 190 may not perform the function corresponding to the bending of the user terminal apparatus 10. In response to the illumination value detected through the illumination sensor 181 being more than or equal to the preset value, the controller 190 may perform the function corresponding to the bending of the user terminal apparatus 10. That is, in response to the user terminal 10 being presented in a bag or in a pouch, because the illumination value of the user terminal apparatus 10 is likely to be less than the preset value, the controller 190 may not perform the function corresponding to the bending of the user terminal apparatus 10 based on the illumination value detected through the illumination sensor 181.

In response to the bending of the user terminal apparatus 10 being detected through the bending sensor 185, the controller 190 may detect whether an object is presented in a periphery of the user terminal apparatus 10 through the proximity sensor 182. In response to the object presented in the periphery of the user terminal apparatus 10 being detected through the proximity sensor 182, the controller 190 may not perform the function corresponding to the bending of the user terminal apparatus 10. In response to the object presented in the periphery of the user terminal apparatus 10 not being detected through the proximity sensor 182, the controller 190 may perform the function corresponding to the bending of the user terminal apparatus 10. That is, in response to the user terminal apparatus 10 being presented in the bag or in the pouch, because the object (e.g., clothing, wallet, book, and the like) is likely to be presented in the periphery of the user terminal apparatus 10, the controller 190 may detect whether the object is presented in a periphery of the user terminal apparatus 10 through the proximity sensor 182, and not perform the function corresponding to the bending of the user terminal apparatus 10 according to the detection result.

In response to the bending of the user terminal apparatus 10 being detected through the bending sensor 185, the controller 190 may detect the motion of the user terminal apparatus 10 using the acceleration sensor 183. In response to a preset motion being detected through the acceleration sensor 183, the controller 190 may not perform the function corresponding to the bending of the user terminal apparatus 10. That is, in response to the user terminal apparatus 10 being bent by the user, the user terminal apparatus 10 may be mostly gripped by the user. However, in response to the user terminal apparatus 10 being presented in a bag or in a pouch differently from the grip state, the user terminal apparatus 10 may have the motion having a certain pattern. That is, in response to the user terminal apparatus 10 having the motion having the certain pattern, the controller 190 may not perform the function corresponding to the bending of the user terminal 10.

The controller 190 may determine whether to perform the function corresponding to the bending of the user terminal apparatus 10 in consideration of the complex use environments of the user terminal apparatus 10 as described above. That is, the controller 190 may determine whether to perform the function corresponding to the bending of the user terminal apparatus 10 based on at least two of an illustration value in the periphery of the user terminal apparatus 10, the proximity of the object in the periphery of the user terminal apparatus 10, and the motion pattern of the user terminal apparatus 10. For example, in response to the illumination value in the periphery of the user terminal apparatus 10 being less than or equal to a preset value, but in response to the object not being presented in the periphery of the user terminal apparatus 10 and the motion pattern of the user terminal apparatus 10 not being presented, the controller 190 may perform the function corresponding to the bending of the user terminal apparatus. In another example, in response to the illumination value in the periphery of the user terminal apparatus 10 being less than or equal to the preset value and the object being presented in the periphery of the user terminal apparatus 10, but in response to the motion pattern of the user terminal apparatus 10 not being presented, the controller 190 may not perform the function corresponding to the bending of the user terminal apparatus. That is, in response to two or more conditions being satisfied, the controller 190 may not perform the function corresponding to the user terminal apparatus 10.

Below, various examples for preventing a malfunction of the user terminal apparatus 10 according to one or more exemplary embodiments will be described with reference to FIGS. 5 to 8.

FIG. 5 is a flowchart illustrating a method of preventing a malfunction according to a mode of the user terminal apparatus 10 according to an exemplary embodiment.

First, the controller 190 may detect bending of the user terminal apparatus 10 (S510). The controller 190 may determine whether the user terminal apparatus 10 is in a sleep mode or a standby mode (S520). The sleep mode may refer to a mode that the display 130 maintains an inactivated state, and the standby mode may be a mode that the display 130 displays a locking release screen. Exemplary embodiments are not limited to this.

In response to the user terminal apparatus 10 being in the sleep mode or the standby mode (S520-Y), the controller 190 may detect a use environment of the user terminal apparatus 10 through a plurality of sensors (S530). For example, the controller 190 may detect the use environment of the user terminal apparatus 10 using at least one of the illumination sensor 181, the proximity sensor 182, the acceleration sensor 183, and the like, as described above.

The controller 190 may determine whether the bending of the user terminal apparatus is a malfunction according to the use environment of the user terminal apparatus 10 (S540). For example, in response to two or more conditions being satisfied among various conditions (e.g., a condition that an illumination value in a periphery of the user terminal apparatus 10 is less than or equal to a preset value, a condition that an object is presented in the periphery of the user terminal apparatus 10, and a condition that a motion having a certain pattern is presented in the user terminal apparatus 10), the controller 190 may determine the bending of the user terminal apparatus 10 as a malfunction.

In response to the bending of the user terminal apparatus 10 being determined as the malfunction (S550-Y), the controller 190 may not perform a function corresponding to the bending of the user terminal apparatus 10 and the controller 190 may maintain a current state of the user terminal apparatus 10 (S560). In response to the bending of the user terminal apparatus 10 not being determined as the malfunction (S550-N), the controller 190 may perform the function corresponding to the bending of the user terminal apparatus 10 (S570).

In response to the user terminal apparatus 10 not being in the sleep mode or the standby mode (S520-N), i.e., the user terminal apparatus 10 being in a normal mode that the display 130 displays a home screen or an application screen, the controller 190 may perform the function corresponding to the bending of the user terminal apparatus 10 in response to the bending of the user terminal apparatus 10 (S570).

As described above, in response to a specific function being performed by the user through a bending input of the user terminal apparatus 10, the same condition as the malfunction condition may be created. For example, in response to a user's hand being placed on the user terminal apparatus 10 in a dark room, the user may wish to operate the user terminal apparatus 10 through a bending input, but the controller may not perform the function corresponding to the bending input because the use environment of the user terminal apparatus 10 is identical with the malfunction condition. Accordingly, the controller 190 may perform the function corresponding to the bending input only during the normal mode, and the controller may determine whether to the bending of the user terminal apparatus 10 is malfunction by detecting the use environment of the user terminal apparatus 10 only in the sleep mode or the standby mode. Accordingly, the user convenience may be improved.

FIG. 6 is a flowchart illustrating a method of preventing a malfunction according to whether a user fingerprint is recognized according to another exemplary embodiment.

First, the controller 190 may detect bending of the user terminal apparatus 10 (S610). The controller 190 may determine whether a user fingerprint is recognized through a fingerprint recognizer (S620).

In response to the user fingerprint not being recognized (S620-N), the controller 190 may detect a use environment of the user terminal apparatus 10 through a plurality of sensors (S630). For example, the controller 190 may detect the use environment of the user terminal apparatus 10 using at least one of the illumination sensor 181, the proximity sensor 182, the acceleration sensor 183, and the like, as described above.

The controller 190 may determine whether the bending of the user terminal apparatus is a malfunction according to the use environment of the user terminal apparatus 10 (S640). For example, in response to two or more conditions being satisfied (e.g., a condition that an illumination value in a periphery of the user terminal apparatus 10 being less than or equal to a preset value, a condition that an object being presented in the periphery of the user terminal apparatus 10, and a condition that a motion having a certain pattern being presented in the user terminal apparatus 10), the controller 190 may determine the bending of the user terminal apparatus 10 as a malfunction.

In response to the bending of the user terminal apparatus 10 being determined as the malfunction (S650-Y), the controller 190 may not perform the function corresponding to the bending of the user terminal apparatus 10 and the controller 190 may maintain a current state of the user terminal apparatus 10 (S660). In response to the bending of the user terminal apparatus 10 not being determined as the malfunction (S650-N), the controller 190 may perform the function corresponding to the bending of the user terminal apparatus 10 (S670).

In response to the user fingerprint being recognized (S620-Y), the controller 190 may perform the function corresponding to the bending of the user terminal apparatus 10 in response to the bending of the user terminal apparatus 10 (S670).

That is, in response to the user fingerprint being recognized, the user is highly like to grip the user terminal apparatus 10. Therefore, the controller 190 may determine whether to the bending of the user terminal apparatus 10 is malfunction by detecting the use environment of the user terminal apparatus 10 only in response to the user fingerprint not being recognized. Accordingly, the user convenience may be further improved.

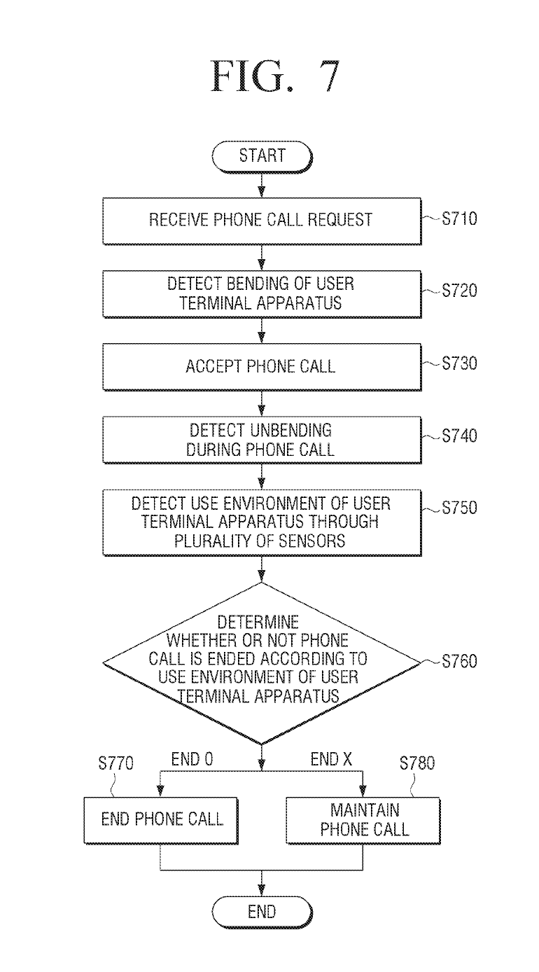

FIG. 7 is a flowchart illustrating a method of preventing a malfunction according to bending of the user terminal apparatus 10 while performing a phone call, according to another exemplary embodiment.

First, the controller 190 may receive a phone call request (S710).

The controller 190 may detect bending of the user terminal apparatus 10 (S720).

The controller 190 may accept the phone call in response to the bending of the user terminal apparatus 10 (S730). That is, the controller 190 may perform a function for accepting the phone call as a function corresponding to the bending of the user terminal apparatus 10.

The controller 190 may detect unbending of the user terminal apparatus 10 during the phone call (S740).

The controller 190 may detect a use environment of the user terminal apparatus 10 through a plurality of sensors (S750). For example, the controller 190 may detect whether the user terminal apparatus 10 is close to a cheek of the user through the illumination sensor 181 or the proximity sensor 182. That is, in response to determining that an illumination value detected through the illumination sensor 181 is less than or equal to a preset value and an object is close to the user terminal apparatus 10 through the proximity sensor 182, the controller 190 may determine that the user terminal apparatus 10 is close to the cheek of the user.

The controller 190 may determine whether to end the phone call according to the use environment of the user terminal apparatus 10 (S760). For example, in response to determining that the user terminal apparatus 10 is close to the cheek of the user, the controller 190 may maintain the phone call (S780). In response to determining that the user terminal apparatus 10 is not close to the cheek of the user, the controller 190 may end the phone call (S770).

Therefore, in response to the user terminal apparatus 10 being unbent regardless of the user's intention during the phone call, the user terminal apparatus 10 may prevent a malfunction by determining whether the user terminal apparatus 10 is close to the cheek of the user.

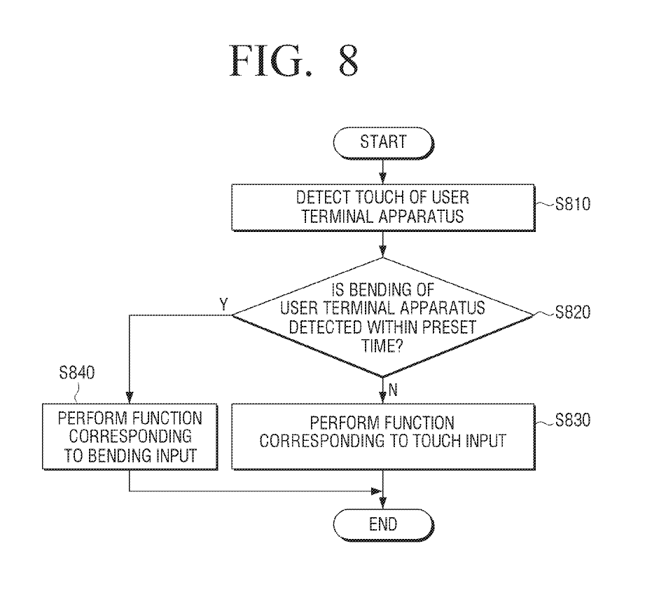

FIG. 8 is a flowchart illustrating a method of processing a touch input and a bending input according to an exemplary embodiment.

First, the controller 190 may detect a touch of the user terminal apparatus (S810).

The controller 190 may determine whether bending of the user terminal apparatus 10 is detected within a preset time (S820).

In response to the bending of the user terminal apparatus 10 being detected within the preset time or less (S820-Y), the controller 190 may perform a function corresponding to the bending input (S830). In response to the bending of the user terminal apparatus 10 not being detected within the preset time (S820-N), the controller 190 may perform a function corresponding to the touch input (S840).

That is, in response to the user terminal apparatus 10 being gripped and bent by the user, the user may touch the display 130 of the user terminal apparatus 10. That is, the user may wish to perform a bending input, but the user terminal apparatus 10 may detect a touch input unintended by the user. Accordingly, the user terminal apparatus 10 may determine whether the touch input is a touch for selecting an icon or a touch unintended in the bending input by determining whether the bending input is detected within the preset time after the touch input.

According to an exemplary embodiment, in response to the bending input for causing the user terminal apparatus 10 to be bent being detected, the controller 190 may divide a screen of the display 130 into two according to the bending input, and provide different applications or different functions to two screens.

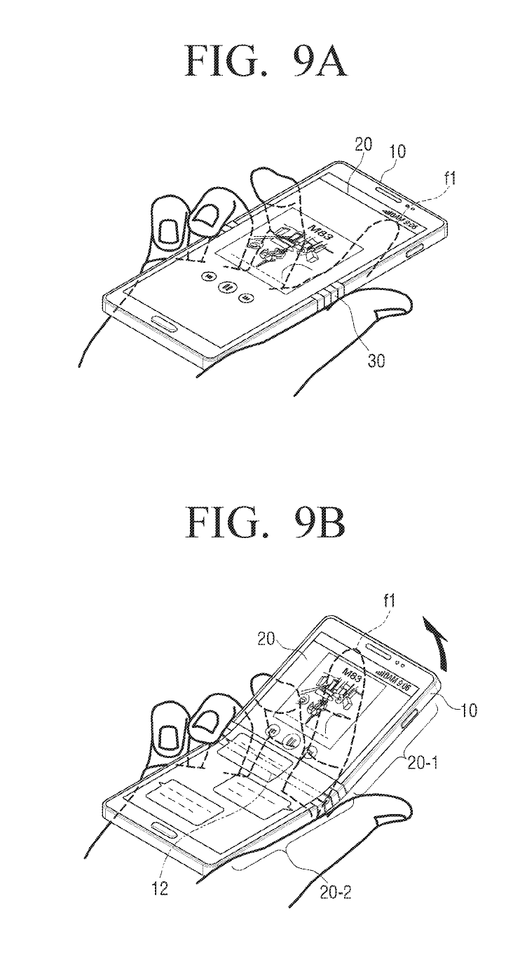

For example, in response to the bending input being detected while an application screen is displayed in the flexible display 20 as illustrated in FIG. 9A, the controller 190 may divide the flexible display 20 into two regions 20-1 and 20-2, and control the flexible display 20 to display different screens in the two regions 20-1 and 20-2 as illustrated in FIG. 9B. A region located in an upper portion of the flexible display 20 may refer to a first region 20-1, and a region located in a lower portion of the flexible display 20 may refer to a second region 20-2.

In response to the bending input being detected while a first application is being executed, the controller 190 may control the flexible display 20 to display a first application screen in the first region 20-1 and to display a second application screen related to the first application in the second region 20-2. For example, in response to the bending input being detected while a camera application is executed, the controller 190 may control the flexible display 20 to display an execution screen of the camera application in the first region 20-1 and to display an image editing application associated to the camera application in the second region 20-2. Exemplary embodiments are not limited to this.

In response to the bending input being detected while the first application is executed, the controller 190 may control the flexible display 20 to display a screen which performs a first function of the first application in the first region 20-1 and to display a screen which performs a second function of the first application in the second region 20-2. For example, in response to the bending input being detected while a text application is executed, the controller 190 may control the flexible display 20 to display a text screen of the text application in the first region 20-1 and to display a text input window of the text application in the second region 20-2.

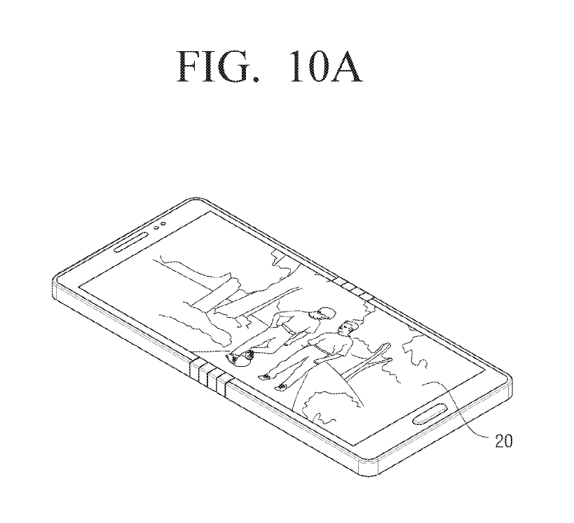

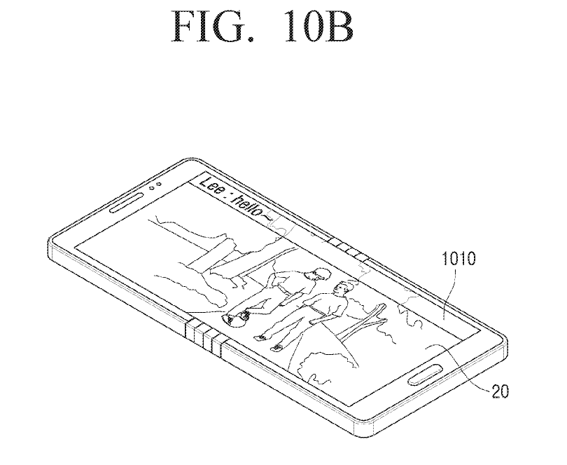

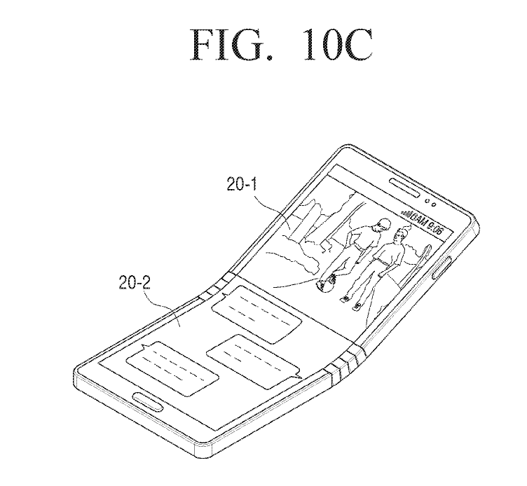

Below, one or more exemplary embodiments will be described with reference to FIGS. 10A to 14D.

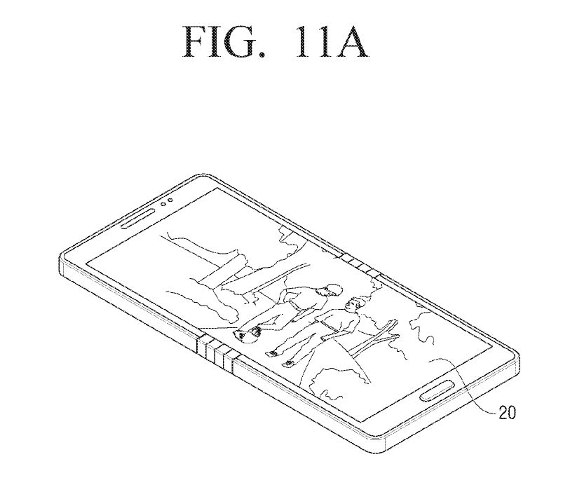

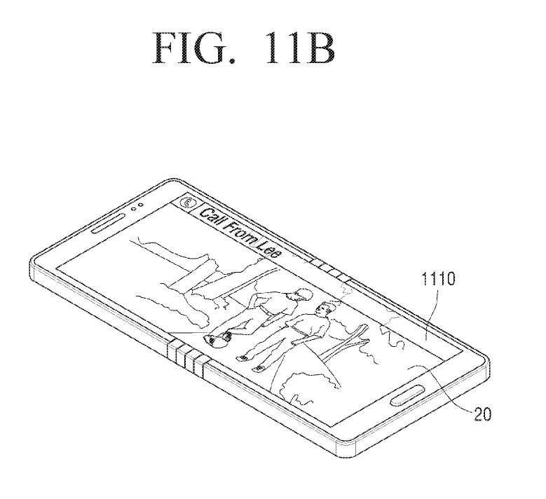

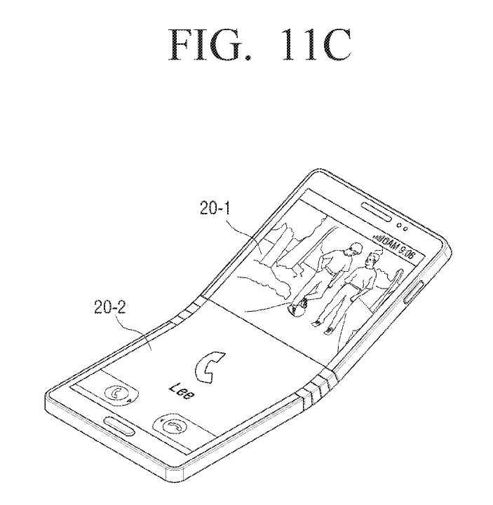

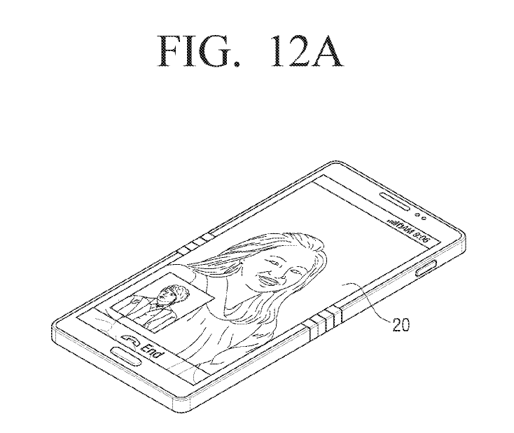

FIGS. 10A to 11C are diagrams illustrating examples which divide a screen through a bending input during moving image application reproduction according to an exemplary embodiment.

As illustrated in FIG. 10A, the controller 190 may control the flexible display 20 to display a screen for a moving image (e.g., video) application.

In response to a message being received from the outside while the screen for the moving image application is displayed, the controller 190 may control the flexible display 20 to display a message reception guide (e.g., message alert) 1010 in an upper end of a display screen as illustrated in FIG. 10B.

In response to a bending input being detected within a preset time after the message reception guide 1010 is displayed, the controller 190 may divide the screen and control the flexible display 20 to display the screen for the moving image application, which is displayed in the display screen, in the first region 20-1 and to display a screen for a text application in the second region 20-2, as illustrated in FIG. 10C.

That is, in response to the text message being received while the moving image is reproduced, the controller 190 may control the moving image to be continuously viewed and control the user to confirm the received text message and reply to the received text message by dividing the display screen through the bending input.

According to another exemplary embodiment, as illustrated in FIG. 11A, the controller 190 may control the flexible display 20 to display the screen for the moving image application.

In response to a phone call being received from the outside while the screen for the moving image application is displayed, as illustrated in FIG. 11B, the controller 190 may control the flexible display 20 to display a call request guide 1110 in an upper end of the display screen.

In response to the bending input being detected while the call request guide 1110 is displayed, as illustrated in FIG. 11C, the controller 190 may divide the screen and control the flexible display 20 to display the screen for the moving image application, which is displayed in the display screen, in the first region 20-1 and to display a screen for a phone application in the second region 20-2. The controller 190 may accept the phone call in response to the bending input, and control the audio output unit 170 to output not audio data of the moving image but audio data of the phone call.

That is, in response to a call request being received during the moving image reproduction, the controller 190 may control the moving image to be continuously viewed and control the user to perform the phone call with other party by dividing the display screen through the bending input.

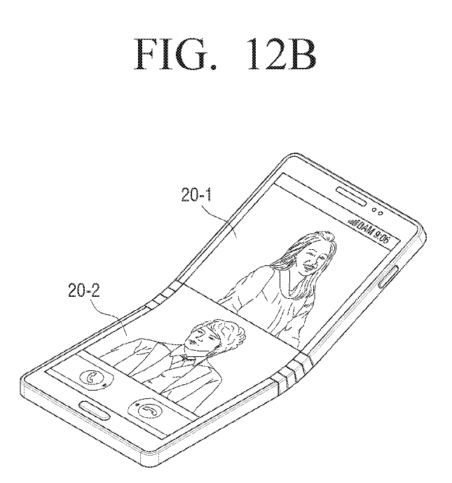

According to another exemplary embodiment, in response to a video or image call with the other party being performed, as illustrated in FIG. 12A, the controller 190 may control the flexible display 20 to display an image for the other party together with an image of the user in one screen.

In response to the bending input being detected while the images of the other party and the user are simultaneously displayed, as illustrated in FIG. 12B, the controller 190 may control the flexible display 20 to display the other party image in the first image 20-1 and to display the user image in the second region 20-2.

That is, because the user terminal apparatus 10 may steadily provide the other party image and the user image by dividing the display screen, the caller's eyes may be changed according to a position of a camera, a face position of the displayed caller, and a face position of the other party in the image calling. Therefore, the problem which gives the other party the feeling that the caller does not look at the other party may be eliminated.

In another example, in response to a plurality of screens being displayed in the first region 20-1 and the second region 20-2, the controller 190 may control the flexible display 20 to display a screen having a small user touch operation (e.g., a moving image screen, and the like) in the first region 20-1 and to display a screen requesting the user touch operation (e.g., a text input screen, and the like) in the second region 20-2.

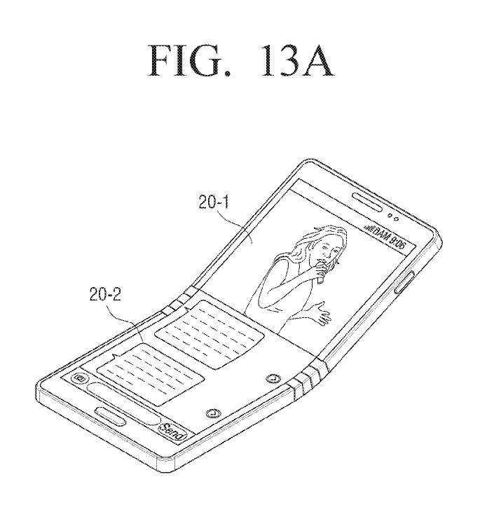

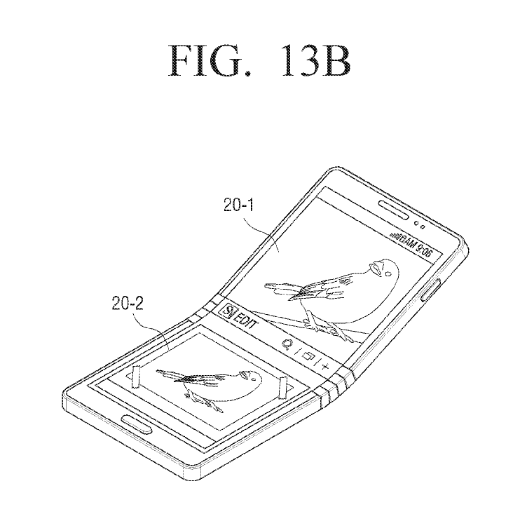

For example, as illustrated in FIG. 13A, a moving image application screen may be displayed in the first region 20-1 and a text application screen may be displayed in the second region 20-2. In another example, as illustrated in FIG. 13B, a gallery image application screen may be displayed in the first region 20-1 and an image editing application screen may be displayed in the second region 20-2.

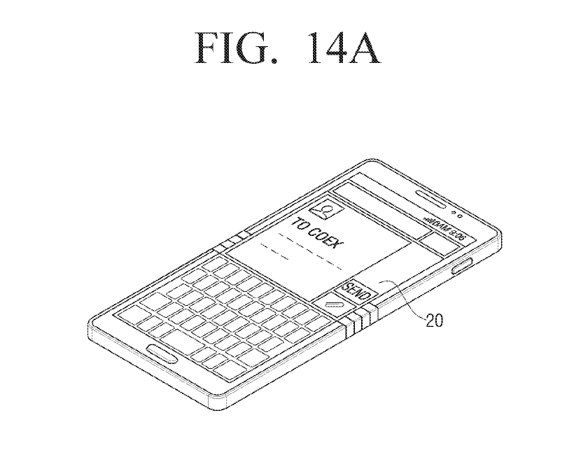

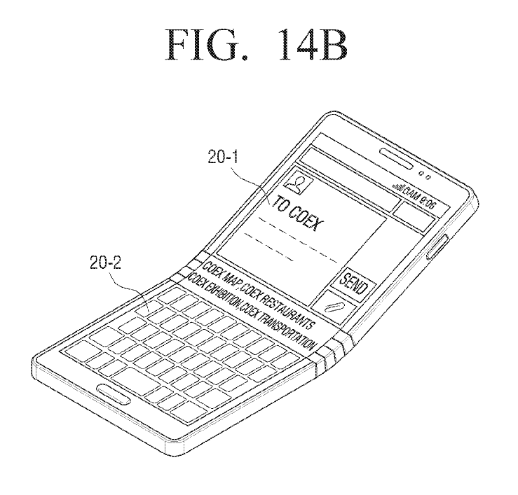

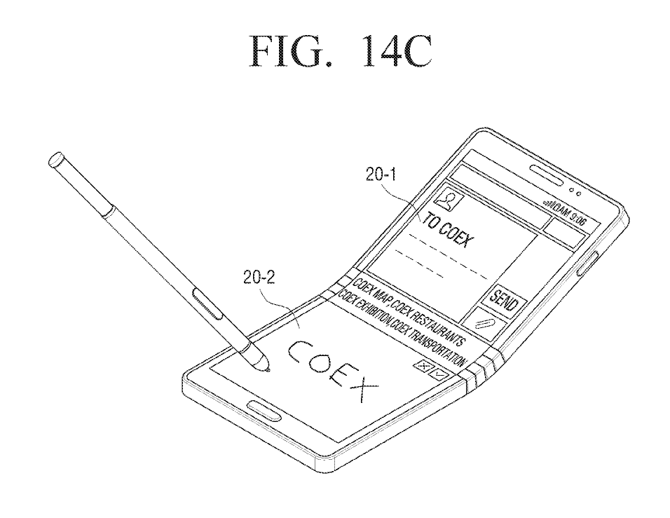

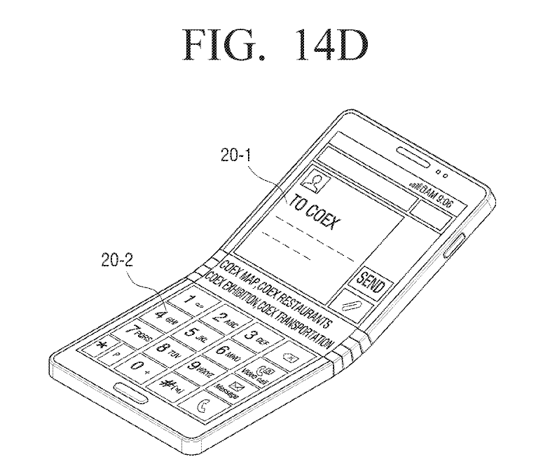

In text message input, as illustrated in FIG. 14A, the controller 190 may control the flexible display 20 to display a text input window in an upper end of the display screen and to display a keyboard screen in a bottom end of the display screen. That is, because the text input window is displayed in an upper portion and the key board is displayed in a lower portion, in response to the user terminal apparatus 10 being gripped on the basis of the user's field of view, the user may have strain on the wrist and in response to the user terminal apparatus 10 being gripped on the basis of the comfort of the wrist, the screen may be viewed in a tilted state to cause irregular reflection, and the text may be viewed in a tilted state.

However, in response to the bending input being detected, the controller 190 may control the flexible display 20 to display a text input window in the first region 20-1 and to display a keyboard in the second region 20-2 as illustrated in FIGS. 14B to 14D. Because the second region 20-2 is larger than the first region 20-1, a region for providing associated searches may be further displayed in the second region 20-2 with the keyboard. Due to the bending of the user terminal apparatus 10, the user grips the user terminal apparatus 10 more conveniently on the basis of user's field of view, and simultaneously the user may input a user touch.

As described above, through providing a plurality of screens in the first region 20-1 and the second region 20-2 through the bending input, the user terminal apparatus 10 may improve the operability of the user and provide a multitasking function.

The controller 190 may provide various functions according to the bending input in various applications.

The controller 190 may provide various functions through the bending input in a phone application. For example, in response to a bending input to the user terminal apparatus 10 being detected after the phone call request is received from the outside in a state in which the user terminal apparatus 10 is in an unbending state, the controller 190 may accept the phone call request. In another example, in response to detecting an input for causing the user terminal apparatus 10 to be unbent or detecting a touch input for touching an END button while the phone call is performed in a state in which the user terminal apparatus 10 is in a bending state, the controller 190 may end the phone call. In another example, in response to the bending input being detected while the phone call is performed in a state in which the user terminal apparatus is in an unbending state, the controller 190 may activate a function to record call content of phone conversation or display a screen for selecting a dial number in the second region 20-2. In another example, in response to the bending input being detected in a state in which a phone dial is displayed after the phone application is executed, the controller 190 may control the flexible display 20 to display a contact associated with an input dial in the first region 20-1 and to display a number for a dial input in the second region 20-2.

The controller 190 may provide various functions through the bending input in a contact application. For example, in response to the bending input being detected after the contact application is executed, the controller 190 may control the flexible display 20 to display a contact list in the first region 20-1 and to display a contact group in the second region 20-2. That is, the controller 190 may provide hierarchical contact information to the user. In another example, in response to the bending input being detected after the contact application is executed, the controller 190 may display a call log or a message history associated with the contact list in the first region 20-1 and to display a search input window or a keypad in the second region 20-2. In another example, in response to the bending input being detected in contact input, the controller 190 may control the flexible display 20 to display an input window for the contact input and input information in the first region 20-1 and to display a keypad, a call history, a message history, and the like, in the second region 20-2.

The controller 190 may provide various functions through a bending input in a text application. For example, in response to the bending input being detected after a message is received, the controller 190 may control the flexible display 20 to display a message window for confirming the received message. In this example, the controller 190 may control the flexible display 20 to display the received message in the first region 20-1 and to display a keypad for creating a reply and a UI for providing additional functions (e.g., associated search word, and the like) in the second region 20-2. In another example, in response to the bending input being detected after an icon for contact addition is touched in a state in which the text application is executed, the controller 190 may control the flexible display 20 to display the added contacts in the first region 20-1 and to display a contact list in the second region 20-2. In another example, in response to an icon for creating a message being selected and the bending input being detected after the text application is executed, the controller 190 may control the flexible display 20 to display created content in the first region 20-1 and to display a keypad for creating a message and a UI for providing additional functions (e.g., associated search word, and the like) in the second region 20-2.

The controller 190 may provide various functions through the bending input in an Internet application. For example, in response to the bending input being detected after the Internet application is executed, the controller 190 may control the flexible display 20 to display an Internet screen in the first region 20-1 and to display at least one of a keypad, a search history, a recommended search word, and an associated search word in the second region 20-2.

The controller 190 may provide various functions through the bending input in a mail application. For example, in response to the bending input being detected after a notice that the mail is received is displayed, the controller 190 may control the flexible display 20 to display the received main content in the first region 20-1 and to display a UI for providing at least one among mail reception and non-reception for a response mail, an attachment function, a keypad, an additional receiver selection function, and an associated search function in the second region 20-2. In another example, in response to the bending input being detected after the mail is confirmed in a mail list in a state in which the mail application is executed, the controller 190 may control the flexible display 20 to display mail creation content in the first region 20-1 and to display a UI for providing at least one among a keypad, an attachment function, an additional receiver selection function, and an associated search function in the second region 20-2. In another example, in response to the bending input being detected after the mail application is executed, and a sensing function is activated by selecting a mail address, the controller 190 may control the flexible display 20 to display mail creation content in the first region 20-1 and to display a UI for providing at least one among a keypad, an attachment function, an additional receiver selection function, and an associated search function in the second region 20-2.

The controller 190 may provide various functions through the bending input in a camera application. For example, in response to the bending input being detected in the sleep mode, the controller 190 may activate the camera application and control the flexible display 20 to display a shoot screen (e.g., image capture screen) in the first region 20-1 and to display a UI such as a shoot button or a mode setup in the second region 20-2. In another example, in response to the bending input being detected in the standby mode state, the controller 190 may control the flexible display 20 to display the shoot screen in the first region 20-1 and to display a screen for requesting a standby mode cancel in the second region 20-2. In another example, in response to the bending input being detected in the normal mode, the controller 190 may control the flexible display 20 to display the shoot screen in the first region 20-1 and to display a UI for controlling a function associated with shooting in the second region 20-2. In another example, in response to the bending input being detected in self-image shooting, the controller 190 may control the flexible display 20 to display the shoot screen in the first region 20-1 and to display a menu for shooting a self-image in the second region 20-2.

The controller 190 may provide various functions through the bending input in a music application. For example, in response to the bending input being detected after the music application is executed, the controller 190 may control the flexible display 20 to display information (e.g., a play time, lyrics, a music-related effect, and the like) related to currently reproduced music in the first region 20-1 and to display a UI for controlling the music application, a playlist, and the like, in the second region 20-2. That is, the controller 190 may control the flexible display 20 to display a playlist, a play button, sharing of music which is playing and music which is held, playlist editing, a recommended music list, information (e.g., an album, contemporary popular music, detailed information for a singer, and the like) related to the played music, popular list information, information for the newest album, and the like, in the second region 20-2.

The controller 190 may provide various functions through the bending input in a moving image (e.g., video) application. For example, in response to the bending input being detected after an event (e.g., message reception, phone reception, mail reception, and the like) that a message is received from the outside is detected during reproduction of a moving image, the controller 190 may control the flexible display 20 to continuously display the moving image which is reproducing in the first region 20-1 and to display a screen (e.g., a reply screen, a phone reception screen, and the like) related to the received event in the second region 20-2.

The controller 190 may provide various functions through the bending input in a social network service (SNS) application. For example, in response to the bending input being detected while a messenger type SNS application is executed, the controller 190 may control the flexible display 20 to display message content which is inputting in the first region 20-1 and to display a keypad, recommended search, file attachment, and the like, in the second region 20-2. In another example, in response to the bending input being detected while the messenger type SNS application is executed, the controller 190 may capture an image by activating the camera application and control the communication unit 140 to transmit the captured image through the messenger application. In another example, in response to the bending input being detected after a picture upload command while the message upload type SNS application is executed, the controller 190 may control the flexible display 20 to display the shoot screen in the first region 20-1 and to display an upload screen and a text input screen in the second region 20-2. In another example, in response to the bending input being detected while the other party confirms text in a state in which the message upload type SNS application is executed, the controller 190 may control the flexible display 20 to display text of other acquaintances in the first region 20-1 and to display a screen for creating a replay for the other acquaintances or text of the user in the second region 20-2.

In response to the bending input being detected while a home screen is displayed or an application is executed, the controller 190 may control the flexible display 20 to display a setup screen. The controller 190 may provide an optimized setup screen corresponding to a current screen. For example, in response to the bending input being detected while an Internet application is executed, the controller 190 may control the flexible display 20 to display the setup screen such as storage or non-storage of a password, storage or non-storage of a cookie, or pop-up setup.

The controller 190 may provide various functions through the bending input in a memo application. For example, in response to the bending input being detected while the memo application is executed, the controller 190 may control the flexible display 20 to display a memo which is created in the first region 20-1 and to display at least one among a keypad, an attachment function, an associated search function, a memo list, a memo storage folder, a memo name to be stored, and memory management in the second region 20-2. In this example, in response to a pen input being possible, the controller 190 may control the flexible display 20 to display a pen input window in the second region 20-2 other than the keypad.

The controller 190 may provide various functions through the bending input in a schedule application. For example, in response to the bending input being detected in a schedule input screen after the schedule application is executed, the controller 190 may control the flexible display 20 to display a schedule in the first region 20-1 and to display at least one among a keypad, a photo, a calendar, a watch, a map, details, a schedule-related message, SNS, and a mail in the second region 20-2. In another example, in response to the bending input being detected after a notice provided from the schedule application is generated, the controller 190 may control the flexible display 20 to display a schedule name and brief information for a schedule in the first region 20-1 and to display detailed information for the schedule, a calendar, and brief information for a position in in the second region 20-2. In this example, in response to a touch input which touches a position to retrieve a detailed position being detected, the controller 190 may control the flexible display 20 to display a map including position information or may activate an augmented reality (AR) load guidance function through camera function activation.

The controller 190 may provide various functions through the bending input in a weather application. For example, in response to the bending input being detected while the weather application is executed, the controller 190 may control the flexible display 20 to display today's weather in the first region 20-1 and to display additional information (e.g., outdoor activity-related proposal, clothing-related proposal, exercise-related proposal, and the like) using today's weather information in the second region 20-2. In another example, in response to the weather application being linked with another application (e.g., health application, schedule application, and the like), the controller 190 may control the flexible display 20 to display guide information related to the linked application (e.g., schedule change proposal, exercise-related proposal, traffic information provision, and the like).

The controller 190 may provide various functions through the bending input in a health application. For example, in response to the bending input being detected while the health application is executed, the controller 190 may control the flexible display 20 to display a health-related history in the first region 20-1 and to display proposed exercise guide information based on the health-related history in the second region 20-2. In another example, the controller 190 may analyze an image state of the user based on picture information (e.g., food pictures and the like, certified by the user in a gallery, SNS, and the like) and a food-related history created in SNS, analyze an activity history of the user through SNS, and provide health-related information and an associated search function in the second region 20-2.

The controller 190 may provide various functions through the bending input in a map application. For example, in response to a camera function being activated and a map function of a menu being selected after the bending input, the controller 190 may control the flexible display 20 to display a captured image or an AR screen in the first region 20-1 and to display a map in the second region 20-2. In another example, in response to the bending input being detected and a camera function being activated while the map application is executed, the controller 190 may control the flexible display 20 to display an AR map service (load guidance service) or detailed information for a position searched for in the map in the first region 20-1 and to display the AR map service (load guidance service) or the map including the position searched for in the map in the second region 20-2.

As described above, various user experiences may be provided through the bending input in various applications.

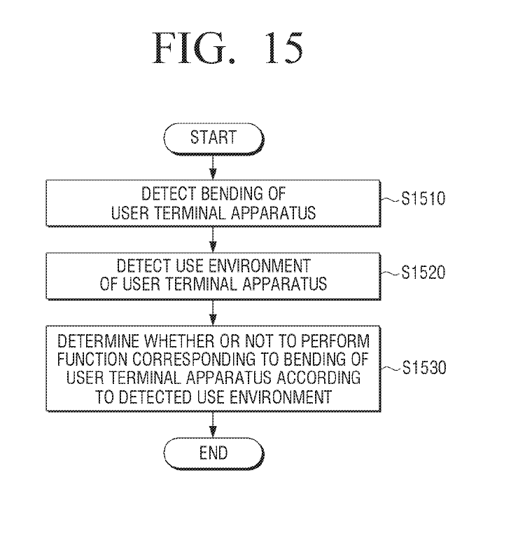

Below, a control method of the user terminal apparatus 10 according to an exemplary embodiment will be described with reference to FIG. 15.

First, the user terminal apparatus 10 may detect bending of the user terminal apparatus 10 (S1510).

The user terminal apparatus 10 may detect a user environment of the user terminal apparatus 10 in response to bending of the user terminal apparatus (S1520). For example, the user terminal apparatus 10 may detect the use environment of the user terminal apparatus 10 using at least one of the illumination sensor 181, the proximity sensor 182, the acceleration sensor 183, and the like.

The user terminal apparatus 10 may determine whether to perform a function corresponding to the bending of the user terminal apparatus 10 according to the detected use environment (S1530). For example, in response to at least one or more conditions being satisfied among various conditions, for example, a condition that an illumination value detected through the illumination sensor 181 being less than a preset value, the user terminal apparatus 10 may not perform the function corresponding to the bending of the user terminal apparatus 10. In another example, in response to an object presented in the periphery of the user terminal apparatus 10 being detected through the proximity sensor 182, the user terminal apparatus 10 may not perform the function corresponding to the bending of the user terminal apparatus 10. In another example, in response to a motion having a preset pattern of the user terminal apparatus 10 being detected through the acceleration sensor 183, the user terminal apparatus 10 may not perform the function corresponding to the bending of the user terminal apparatus 10. In another example, the controller 190 may determine whether to perform the function corresponding to the bending of the user terminal apparatus 10 in consideration of the complex use environments of the user terminal apparatus as described above.

According to an exemplary embodiment, the user terminal apparatus 10 may prevent a malfunction due to an unintentional bending of the user terminal apparatus.

The above-described methods may be created in a program executable by a computer, and may be implemented in a general-purpose computer which executes the program using a non-transitory computer-readable recording medium. A structure of data used in the above-described methods may be recorded in the non-transitory computer-readable recording medium through various devices. The non-transitory computer-readable medium may include storage medium such as a magnetic storage medium (e.g., ROM, floppy disc, a hard disc, and the like) or an optical readable medium (e.g., a compact disc (CD), a digital versatile disc (DVD), and the like).

The foregoing exemplary embodiments are merely exemplary and are not to be construed as limiting the present disclosure. The exemplary embodiments can be readily applied to other types of apparatuses and methods. Also, the description of the exemplary embodiments is intended to be illustrative, and not to limit the scope of the claims, and many alternatives, modifications, and variations will be apparent to those skilled in the art.

What is claimed is:

1. A user terminal apparatus comprising:
a flexible display configured to be divided into a first region and a second region in response to the user terminal apparatus being bent;
a bending detector configured to detect a bending angle of the user terminal apparatus;
at least one sensor configured to detect a use environment of the user terminal apparatus; and
a controller configured to:
determine whether the user terminal apparatus is in a bended state or an unbended state according to the bending angle of the user terminal apparatus;
detect the use environment of the user terminal apparatus through the at least one sensor in response to determining that the user terminal apparatus is in the bended state; and
determine whether to perform a function corresponding to the bended state of the user terminal apparatus according to the detected use environment.

2. The user terminal apparatus of claim 1, wherein the at least one sensor comprises an illumination sensor configured to detect an illumination value representing an amount of illumination near the user terminal apparatus, and
wherein the controller is further configured to not perform the function corresponding to the bended state of the user terminal apparatus in response to detecting that the illumination value is less than a predetermined value.

3. The user terminal apparatus of claim 1, wherein the at least one sensor comprises a proximity sensor configured to detect an object near the user terminal apparatus, and
wherein the controller is further configured to not perform the function corresponding to the bended state of the user terminal apparatus in response to detecting that an object is within a predetermined distance of the user terminal apparatus.

4. The user terminal apparatus of claim 1, wherein the at least one sensor comprises an acceleration sensor configured to detect a motion of the user terminal apparatus, and
wherein the controller is further configured to not perform the function corresponding to the bended state of the user terminal apparatus in response to detecting a predetermined motion.

5. The user terminal apparatus of claim 1, wherein the controller is further configured to, in response to the user terminal apparatus being in a sleep mode or a standby mode, determine whether to perform the function corresponding to the bended state of the user terminal apparatus according to the detected use environment.

6. The user terminal apparatus of claim 1, further comprising a fingerprint recognizer configured to recognize a fingerprint of a user,
wherein the controller is further configured to, in response to a fingerprint of a user being recognized through the fingerprint recognizer, perform the function corresponding to the bended state of the user terminal apparatus regardless of the detected use environment.

7. The user terminal apparatus of claim 1, wherein the controller is further configured to, in response to a call request being received, accept the call request if the user terminal apparatus is in the bended state, and determine whether to end the call according to a sensing value detected through the at least one sensor in response to detecting that the user terminal apparatus enters the unbended state while the call is being performed.

8. The user terminal apparatus of claim 7, wherein the at least one sensor comprises at least one of a proximity sensor and an illumination sensor, and
the controller is further configured to, in response to detecting that the user terminal apparatus enters the unbended state, maintain the call if the proximity sensor or the illumination sensor detects that the user terminal apparatus is close to a user.

9. The user terminal apparatus of claim 1, wherein the at least one sensor comprises a touch sensor, and
wherein the controller is further configured to, in response to the bended state of the user terminal apparatus being detected within a predetermined time after a touch is recognized through the touch sensor, perform the function corresponding to the bended state of the user terminal apparatus, and in response to the bended state of the user terminal apparatus not being detected within the predetermined time after the touch is recognized through the touch sensor, perform a function corresponding to the touch.

10. A method of controlling a user terminal apparatus, the method comprising:
detecting a bending angle of the user terminal apparatus;
determining whether the user terminal is in a bended state or an unbended state according to the bending angle of the user terminal apparatus;
detecting a use environment of the user terminal apparatus in response to determining that the user terminal apparatus is in the bended state; and
determining whether to perform a function corresponding to the bended state of the user terminal apparatus according to the detected use environment.

11. The method of claim 10, wherein the detecting of the use environment of the user terminal apparatus comprises detecting an illumination value representing an amount of illumination near the user terminal apparatus using an illumination sensor, and
the determining comprises determining that the function corresponding to the bended state of the user terminal apparatus is not performed in response to the illumination value detected through the illumination sensor being less than a predetermined value.

12. The method of claim 10, wherein the detecting of the use environment of the user terminal apparatus comprises detecting an object near the user terminal apparatus through a proximity sensor, and
the determining comprises determining that the function corresponding to the bended state of the user terminal apparatus is not performed in response to an object being detected within a predetermined distance of the user terminal apparatus through the proximity sensor.

13. The method of claim 10, wherein the detecting of the use environment of the user terminal apparatus comprises detecting a motion of the user terminal apparatus through an acceleration sensor, and
the determining comprises determining that the function corresponding to the bended state of the user terminal apparatus is not performed in response to a predetermined motion being detected through the acceleration sensor.

14. The method of claim 10, wherein the determining comprises determining, in response to the user terminal apparatus being in a sleep mode or a standby mode, whether to perform the function corresponding to the bended state of the user terminal apparatus according to the detected use environment.

15. The method of claim 10, further comprising recognizing a fingerprint of a user, and
wherein the determining comprises determining that the function corresponding to the bended state of the user terminal apparatus is performed regardless of the detected use environment in response to a fingerprint of a user being recognized through a fingerprint recognizer.

16. The method of claim 10, further comprising:
receiving a call request;
accepting the call request in response to detecting that the user terminal apparatus is in the bended state; and
determining whether to end a call according to a sensing value detected through a sensor of the user terminal apparatus in response to detecting that the user terminal apparatus enters the unbended state.

17. The method of claim 16, wherein the sensor comprises at least one of a proximity sensor and an illumination sensor, and
the determining whether to end the call comprises maintaining the phone call in response to determining through the proximity sensor or the illumination sensor that the user terminal apparatus is close to a user when the user terminal apparatus enters the unbended state.

18. The method of claim 10, further comprising:
performing the function corresponding to the bended state of the user terminal apparatus in response to the bended state of the user terminal apparatus being detected within a predetermined time after a touch of the user terminal apparatus is recognized through a touch sensor; and
performing a function corresponding to the touch of the user terminal apparatus in response to the bended state of the user terminal apparatus not being detected within the predetermined time after the touch of the user terminal apparatus is recognized through the touch sensor.

19. A user terminal apparatus comprising:
a flexible display configured to be bent by a user;
a bending detector configured to detect a bending angle of the flexible display;
a controller configured to:
determine whether the user terminal apparatus is in a bended state or an unbended state according to the detected bending angle; and
in response to determining that the user terminal apparatus changes from the unbended state to the bended state, divide the flexible display into a first region and a second region.

20. The user terminal apparatus of claim 19, wherein the first region is configured to display a first function of a currently executed application and the second region is configured to display a second function of the currently executed application.
